(19) United States
(12) Patent Application Publication
(10) Pub. No.: US 2021/0094226 A1
(43) Pub. Date: Apr. 1, 2021

(54) OXIDATION POLYMERIZATION ADDITIVE MANUFACTURING

(71) Applicant: The Curators of the University of Missouri, Columbia, MO (US)

(72) Inventors: Jonghyun Park, Rolla, MO (US); Tazdik Patwary Plateau, Rolla, MO (US); Hiep Pham, Rolla, MO (US)

(73) Assignee: The Curators of the University of Missouri, Columbia, MO (US)

(21) Appl. No.: 17/034,586

(22) Filed: Sep. 28, 2020

Related U.S. Application Data
(60) Provisional application No. 62/906,463, filed on Sep. 26, 2019.

(51) Int. Cl. B29C 64/159; B29C 64/209; B29C 64/245

(52) U.S. Cl. CPC B29C 64/159; B33Y 10/00; B29C 64/245; B29C 64/209

(57) ABSTRACT

Various processes for producing three dimensional electrically conductive polymer structures, such as three dimensional structures of poly(3,4-ethylenedioxythiophene), are described as well as materials produced by these processes.

### CROSS REFERENCE TO RELATED APPLICATIONS

This application claims priority to U.S. provisional application Ser. No. 62/906,463, filed on Sep. 26, 2019, the entire disclosure of which is incorporated herein by reference.

### FIELD OF THE INVENTION

The present invention relates to various processes for producing three dimensional electrically conductive polymer structures, such as three dimensional structures of poly(3,4-ethylenedioxythiophene), and materials produced by these processes.

### BACKGROUND OF THE INVENTION

In additive manufacturing for the polymer materials, 3D printing technology is popular to make three dimensional objects. In general, polymer materials are flexible but do not have good electrical conductivity. On the other hand, metals have very good electrical conductivity but are not so flexible. In order to provide for high electrical conductivity with flexibility, conductive polymers can be used. For example, poly(3,4-ethylenedioxythiophene) (PEDOT) exhibits high conductivity among conductive polymers. PEDOT is conventionally made by a vapor phase polymerization technique where the monomer EDOT (3,4-ethylenedioxythiophene) is vaporized and contacted with an oxidant to form PEDOT. The typical oxidant materials are ferric chloride (FeCl₃), iron(III) p-toluenesulfonate hexahydrate (FeTos), and graphene oxide (GO). The main limitation for this type of PEDOT fabrication is the inability to make bulk form using layer-by-layer manufacturing. The conventional vapor phase polymerization processes are limited to surface layers only. Accordingly, there remains a need for new approaches of polymerizing layers of conductive polymers to form three-dimensional electrically conductive structures.

### BRIEF SUMMARY OF THE INVENTION

Aspects of the present invention relate to processes for forming three-dimensional electrically conductive structures. Various processes comprise: depositing a first quantity of an oxidant for a monomer (e.g., EDOT) onto a substrate; depositing a first quantity of the monomer onto the oxidant to polymerize the monomer and form a first layer of a conductive polymer (e.g., PEDOT), depositing a second quantity of the oxidant for the monomer onto the first layer of the conductive polymer; and depositing a second quantity of the monomer onto the second quantity of the oxidant to polymerize the monomer and form a second layer of polymer.

Other processes for forming three-dimensional electrically conductive structures comprise: simultaneously spraying a monomer (e.g., EDOT) and an oxidant for the monomer toward a substrate, wherein the monomer and the oxidant react with each other to form a conductive polymer (e.g., PEDOT) disposed on the substrate to form the three-dimensional electrically conductive structure.

Further aspects of the present invention relate to materials produced by these processes. Various materials comprise: a substrate, and a three-dimensional electrically conductive structure comprising a plurality of layers of a conductive polymer disposed on the substrate.

Other objects and features will be in part apparent and in part pointed out hereinafter.

### BRIEF DESCRIPTION OF THE DRAWINGS

FIG. 1(a): Schematic diagram of a two nozzle system for a polymerization technique of the present invention.

FIG. 1(b): Image of an experimental setup for a polymerization technique of the present invention.

FIG. 1(c): Schematic diagram of a nozzle system having an inner and outer nozzle.

FIG. 2: Formation of PEDOT from EDOT monomers by using (a) graphene oxide oxidant according to: (a) a polymerization technique of the present invention and (b) vapor phase polymerization.

FIG. 3: Image of a laboratory-scale 3-D printer.

FIG. 4: Images of a vapor phase polymerization chamber.

FIG. 5: Images of a printed structure of oxidant layer and PEDOT.

FIG. 6: Schematic diagram of a PEDOT formation process including an ultrasonic atomization technique.

FIG. 7: Schematic diagram of a PEDOT formation process including a rotating disc atomization technique.

FIG. 8: Schematic diagram of a PEDOT formation process including a spray cooling technique.

FIG. 9: SEM images for materials composed of conductive polymer PEDOT and NMC 811 particles prepared by (a) a polymerization technique of the present invention and (b) vapor phase polymerization.

FIG. 10: PEDOT structure by using (a) a polymerization technique of the present invention and (b) vapor phase polymerization.

FIG. 11(a): Comparison of the electrical conductivity of a PEDOT sample prepared by vapor phase polymerization (VPP) and 30 micron thick samples prepared by a polymerization technique of the present invention (OURS).

FIG. 11(b): Comparison of the electrical conductivity of a PEDOT sample prepared by vapor phase polymerization (VPP) and 80 to 100 micron thick samples prepared by a polymerization technique of the present invention (OURS).

FIG. 11(c): Comparison of the electrical conductivity of PEDOT samples prepared by vapor phase polymerization (VPP) and a polymerization technique of the present invention (OURS) after scratching the samples to measure bulk conductivity.

FIG. 12(a): Cyclic voltammetry of PEDOT fabricated by a polymerization technique of the present invention.

FIG. 12(b): Cyclic voltammetry of PEDOT fabricated by vapor phase polymerization.

FIG. 13(a): FIB-SEM image of PEDOT formed by a polymerization technique of the present invention.

FIG. 13(b): EDS results of PEDOT formed by a polymerization technique of the present invention.

FIG. 13(c): FIB-SEM image of PEDOT formed by vapor phase polymerization.

FIG. 13(d): EDS results of PEDOT formed by vapor phase polymerization.

### DETAILED DESCRIPTION

The present invention relates to various processes of producing three dimensional electrically conductive polymer structures and materials produced by these processes. In particular, the present invention includes various processes for producing three dimensional structures of conductive polymers such as poly(3,4-ethylenedioxythiophene) and related materials. By these processes, conductive polymers can be fabricated in a layer-by-layer fashion. Also, these processes make possible continuous extrusion of conductive polymer materials.

In these processes, the monomer can be selected from the group consisting of thiophene; 3,4-ethylenedioxythiophene; pyrrole; and aniline. Also, the conductive polymer can be selected from the group consisting of polythiophene; poly(3,4-ethylenedioxythiophene); polypyrrole; and polyaniline. A preferred monomer and its corresponding conductive polymer are 3,4-ethylenedioxythiophene (EDOT) and poly(3,4-ethylenedioxythiophene) (PEDOT).

Various processes of the present invention employ a combination of electro-hydrodynamic printing and polymerization. In these processes, 3D printing is preferably used for the oxidant layer and the droplets of the monomer (e.g., EDOT). Upon contact with the oxidant, monomer (e.g., EDOT) oxidatively polymerizes to form the conductive polymer (e.g., PEDOT). Generally, these processes proceed at a much higher rate than conventional vapor phase polymerization processes.

Importantly, successive layers of a conductive polymer (e.g., PEDOT) can be formed by the processes of the present invention described herein. Accordingly, in various embodiments, the process comprises depositing a first quantity of an oxidant for a monomer (e.g., EDOT) onto a substrate; depositing a first quantity of the monomer onto the oxidant to polymerize the monomer and form a first layer of a conductive polymer (e.g., PEDOT); depositing a second quantity of the oxidant for the monomer onto the first layer of the conductive polymer; and depositing a second quantity of the monomer onto the second quantity of the oxidant to polymerize the monomer and form a second layer of polymer, wherein the monomer is selected from the group consisting of thiophene; 3,4-ethylenedioxythiophene; pyrrole; and aniline, and wherein the conductive polymer is selected from the group consisting of polythiophene; poly(3,4-ethylenedioxythiophene); polypyrrole; and polyaniline. In some embodiments, the process comprises depositing a first quantity of an oxidant for 3,4-ethylenedioxythiophene onto a substrate (e.g., aluminum, or other metal substrate); depositing a first quantity of 3,4-ethylenedioxythiophene monomer onto the oxidant to polymerize the 3,4-ethylenedioxythiophene monomer and form a first layer of poly(3,4-ethylenedioxythiophene); depositing a second quantity of the oxidant onto the first layer of poly(3,4-ethylenedioxythiophene); and depositing a second quantity of 3,4-ethylenedioxythiophene monomer onto the second quantity of the oxidant to polymerize the 3,4-ethylenedioxythiophene monomer and form a second layer of poly(3,4-ethylenedioxythiophene).

In some embodiments, the process further comprising repeating the foregoing steps of depositing the oxidant and depositing the monomer to form a plurality of layers of the conductive polymer. Many layers of the conductive polymer can be formed. In certain embodiments, at least 3, at least 4, at least 5, at least 6, at least 7, at least 8, at least 9, or at least 10 layers of the conductive polymer are formed.

As noted, vapor phase polymerization (VPP) techniques are suitable for making PEDOT from EDOT monomer and oxidant such as ferric chloride, ferric nitrate, iron (III) p-toluenesulfonate (FeTos), molybdenum chloride, and graphene oxide (GO). Oxidant solutions can contain different solvents such as pyridine, n-butanol, and acetonitrile. Vapor phase polymerization processes are conducted in a vacuum or non-reacting argon atmosphere where the vaporization of the EDOT liquid is done at elevated temperature. The vapor of EDOT contacts the oxidant and is polymerized to form PEDOT. However, the PEDOT produced by vapor phase polymerization process is not extrudable. As such, it cannot be used in 3D printing directly because of the insoluble nature of the PEDOT. Thus, it is not possible to produce PEDOT in bulk form using vapor phase polymerization techniques. Instead, PEDOT produced using vapor phase polymerization process techniques is limited to surface coatings.

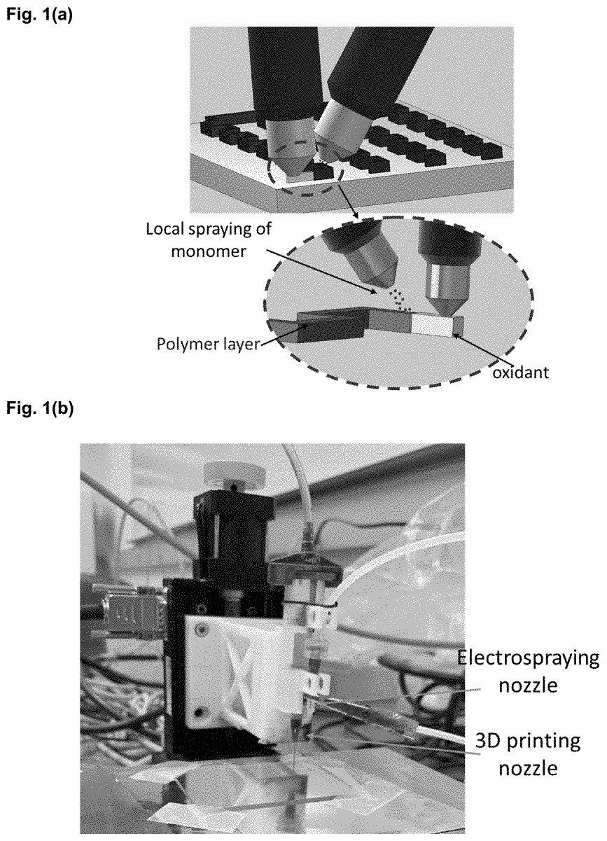

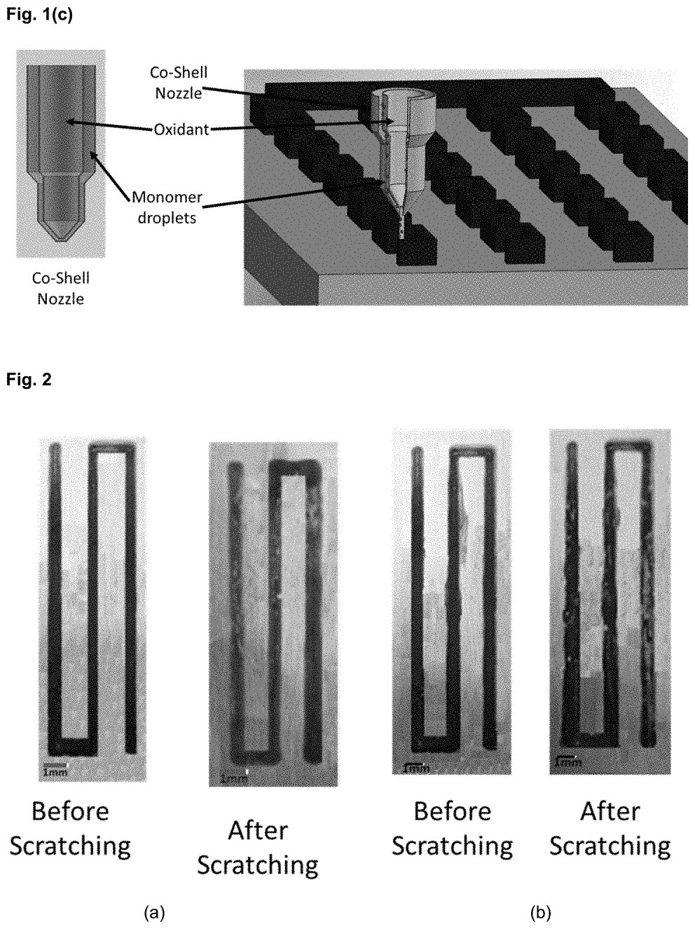

To produce bulk a conductive polymer such as PEDOT in a layer-by-layer fashion, the 3D printing of the oxidant or oxidant solution is used to create a layer-by-layer structure (via a first nozzle), and local spraying of the monomer droplets can be supplied by a second nozzle as shown in FIG. 1(a), FIG. 1(b), and FIG. 1(c). In the oxidative polymerization, the atomized particles of the monomer (e.g., EDOT) are oxidized by the oxidant to form free radicals of the monomer. The free radicals of the monomer react with each other to form a conjugated backbone of the conductive polymer.

In various embodiments, the oxidant for the monomer comprises at least one component selected from the group consisting of ferric chloride, ferric nitrate, iron (III) p-toluenesulfonate (FeTos), molybdenum chloride, and graphene oxide (GO). The oxidant for the monomer and/r the monomer can be provided as mixtures with one or more organic solvents. Various organic solvents including organic polar solvents. Examples of organic polar solvents include alcohols, such as methanol, ethanol, isopropanol, and n-butanol. Other examples of organic polar solvents include nitrogen-containing solvents such as pyridine and acetonitrile. In some embodiments, the solvent comprises or is pyridine, n-butanol and/or acetonitrile solvents. Generally, the solvent is well-mixed with the oxidant, particularly as is dispensed through the nozzle.

Various processes of the present invention comprise simultaneously spraying a monomer (e.g., EDOT) and an oxidant for the monomer toward a substrate, wherein the monomer and the oxidant react with each other to form a conductive polymer (e.g., PEDOT) on the substrate (thereby forming the three-dimensional electrically conductive structure). The monomer and the oxidant for the monomer can be sprayed through a nozzle device which keeps the monomer and the oxidant for the monomer separate until exiting the nozzle device.

Two different methods for supplying the monomer droplets are shown in the figures. The first method is shown in FIG. 1(a) where the monomer and the oxidant solution are supplied by the two different nozzles (i.e., a first nozzle and a second nozzle). An experimental setup having two different nozzles is shown in FIG. 1(b).

The second method for the formation of the conductive polymer PEDOT uses a nozzle device comprising an inner nozzle and an outer nozzle. In some embodiments, the oxidant is sprayed through the inner nozzle and the monomer is sprayed through the outer nozzle (or vice versa). At the tip of the nozzle, the oxidant and the monomer (e.g., EDOT) react with each other to form the conductive polymer (e.g., PEDOT) (FIG. 1(c)).

In vapor phase polymerization techniques for manufacturing PEDOT, the liquid EDOT is heated to about 110° C. to produce EDOT vapor, which flows towards the oxidant. In processes of the present invention, atomization of the monomer particles can be used to direct the flow of the monomer (e.g., EDOT) to the oxidant to initiate the reaction. Various techniques can be used to atomize (e.g., to a particle size of about 15 microns or less) the monomer or a solution of the monomer. Atomization can be achieved using an electric field, which is referred to as electro-spraying. Electro-spraying of the monomer produces small droplets of the monomer and causes the reaction with the oxidant layer that is 3D-printed on the substrate. As a result, the monomer droplets react with the oxidant, and the oxidative polymerization reaction occurs as well as formation of a conjugated backbone chain for the conductive polymer. By this technique, the conductive polymer can be made as a bulk form in layer-by-layer fashion.

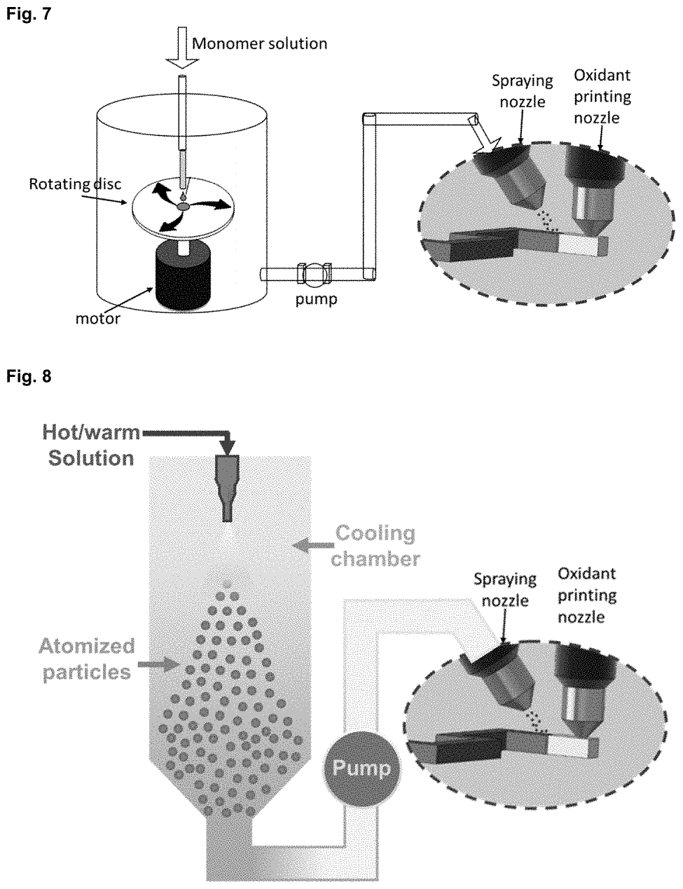

Other techniques can be used to atomize the monomer into small droplets. For example, ultrasonic vibration can be used to atomize the monomer for delivery through the spray nozzle to supply the monomer droplets. FIG. 6 shows a schematic diagram of a conductive polymer formation process including an ultrasonic atomization technique. Another technique includes a rotating disc atomization process, which is shown in FIG. 7. In the rotating disc atomization process, the monomer or solution thereof is fed to the rotating disc where, because of the high speed of the rotation of the disc, the large droplets are converted to small droplets. A suction pump is used to feed the small droplets to the spraying nozzle.

Still another technique for developing the atomized droplets is through spray cooling atomization (FIG. 8). In a spray cooling atomization technique, a heated monomer solution is delivered to a heated atomizing nozzle. As it is sprayed, the solution atomizes upon contact with the cooled chamber producing atomized particles. The formed atomized particles are then delivered to the spraying nozzle via a pump.

Accordingly, in various embodiments, the monomer is atomized by a technique selected from the group consisting of electro-spraying, ultrasonic atomization, rotating disk atomization, spray cooling atomization, and combinations thereof.

Processes of the present invention can further include additional steps. For example, the processes can further comprise depositing a lithium metal oxide on the substrate (e.g., prior to forming the conductive polymer). In some embodiments, lithium metal oxide comprises a lithium nickel manganese cobalt oxide. In certain embodiments, the lithium metal oxide is represented by the formula LiNiₓMn_{y}Co_{1-x-y}O₂ (NMC).

As noted, the present invention further relates to materials produced by the processes described herein. Various materials comprise: a substrate, and a three-dimensional electrically conductive structure comprising a plurality of layers of a conductive polymer disposed on the substrate. The conductive polymer can be selected from the group consisting of polythiophene; poly(3,4-ethylenedioxythiophene); polypyrrole; and polyaniline.

The three-dimensional electrically conductive structure can further comprise additional components such as metal particles. For example, the metal particles can comprise lithium metal oxide. In some embodiments, lithium metal oxide comprises a lithium nickel manganese cobalt oxide. In certain embodiments, the lithium metal oxide is represented by the formula LiNiₓMn_{y}Co_{1-x-y}O₂ (NMC).

The three-dimensional electrically conductive structures formed by the present invention exhibit enhanced conductivity as compared to materials formed by conventional vapor phase polymerization. For example, the structures can have a conductivity that is about 150 S/cm or greater, about 175 S/cm or greater, about 200 S/cm or greater, about 225 S/cm or greater, about 250 S/cm or greater, from about 200 S/cm to 500 S/cm, from 225 S/cm to about 400 S/cm, or from about 250 S/cm to about 350 S/cm.

Having described the invention in detail, it will be apparent that modifications and variations are possible without departing from the scope of the invention defined in the appended claims.

### EXAMPLES

The following non-limiting examples are provided to further illustrate the present invention.

### Example 1

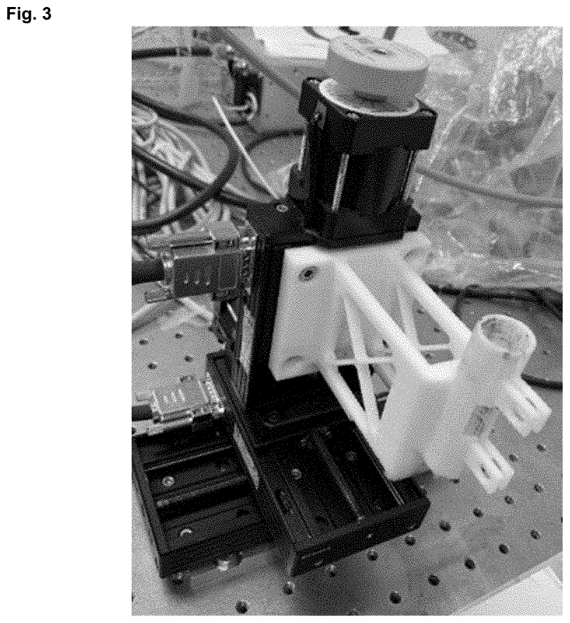

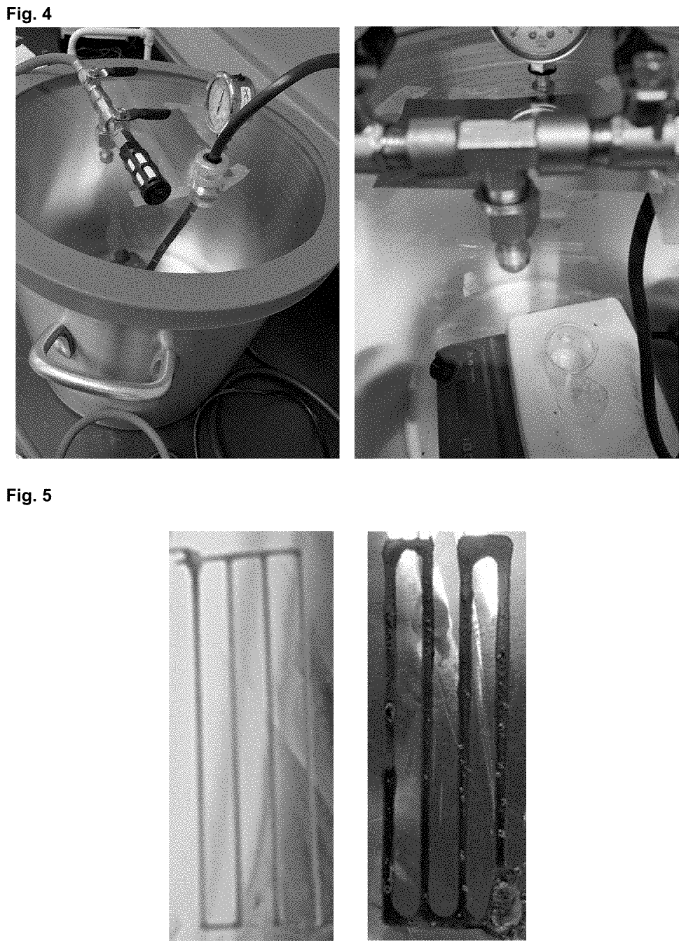

In this experiment, PEDOT was formed by using an electro-spraying technique where a high electric field was created with an applied voltage of 8000 V and where the nozzle tip to substrate distance was 3 cm. See FIG. 2, panel (a). In these experiments, graphene oxide was used as the oxidant. After fabricating the printed layer with PEDOT, the conductivity was measured at 250.7 S/cm. For comparison with conventional vapor phase polymerization, the oxidant layer structure was made first by using a laboratory-built 3D printer (FIG. 3). Then, the oxidant was inserted in a vacuum chamber (FIG. 4) followed by vaporization of the EDOT monomers. The conductive polymer PEDOT formed is shown in FIG. 2, panel (b). The sample polymerized by vapor phase polymerization process had an electrical conductivity of 166.67 S/cm. For the conventional vapor phase polymerization process, the polymer PEDOT was only formed on the surface and for our approach the conductive polymer PEDOT was formed in the bulk in layer-by-layer. A scratching test was performed to further explore the differences between these two processes. The electrical concavity after scratching increased for the new approach (256.25 S/cm) and decreased for the conventional vapor phase polymerization process (138.88 S/cm).

### Example 2

In this experiment, PEDOT was formed using a ferric chloride (FeCl₃) oxidant in acetonitrile solvent. First, a slurry was prepared including the ferric chloride (FeCl₃) and acetonitrile solution. 4.5 g of FeCl₃ and 1 ml acetonitrile were mixed together by using a speed mixer (Flack Tech Inc.) at 3500 RPM for 15 minutes. Then, the slurry was printed on an aluminum foil substrate by using a laboratory-built 3D printer. The printing speed was 30 mm/s. The flow rate was adjusted to form a controlled geometric structure. After printing, the substrate was placed inside a vacuum chamber for the vapor phase polymerization. A hot plate was placed inside the vacuum chamber for heating the EDOT liquid to evaporate the EDOT on the oxidant layer. The vacuum pressure was maintained at 0.5 bar and the temperature of the hot plate was 100° C. The substrate was attached on the bottom of the lid of the vacuum chamber. In this conventional vapor phase polymerization process, the polymerization only occurred on the surface such that entire PEDOT structure could not be made.

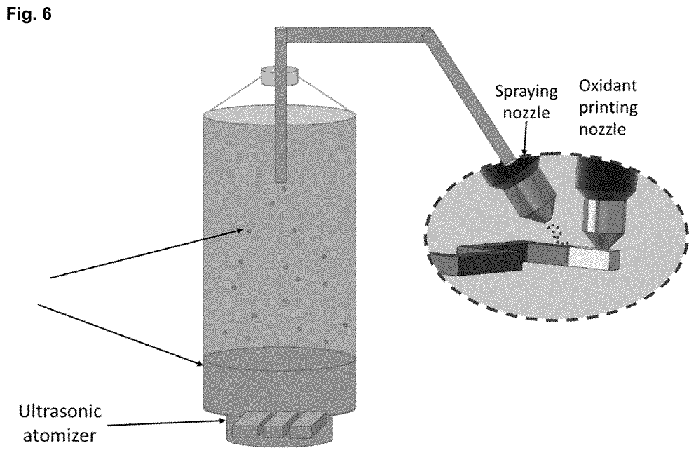

For the new polymerization technique, the deposition of the oxidant layer was done by the 3D printer at a printing speed of 30 mm/s and at the same time continuous electro-spraying (applied voltage 8000 V, flow rate 0.005 ml/hour) of the monomer EDOT solution (1 ml EDOT in 10 ml acetonitrile) formed PEDOT by the polymerization reaction of EDOT and the oxidant. In this continuous polymerization process, entire structure of PEDOT was formed in a layer-by-layer fashion. See FIG. 5.

### Example 3

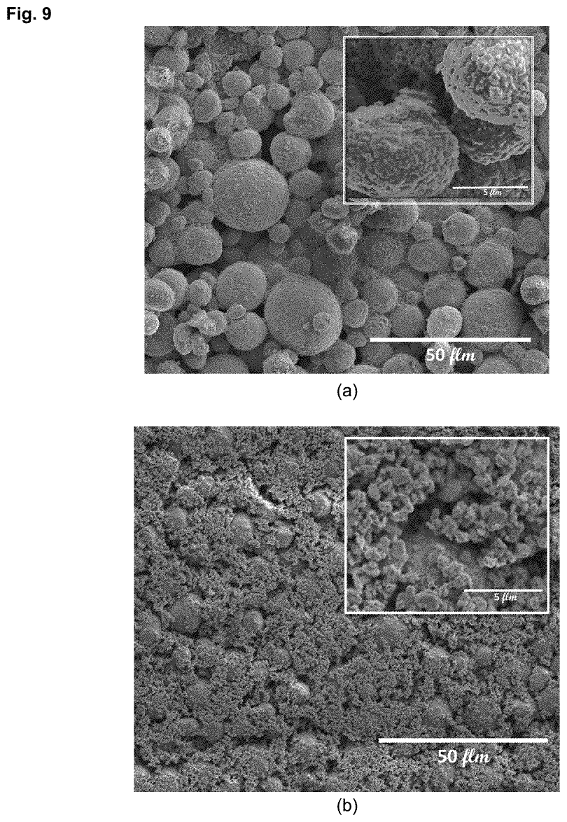

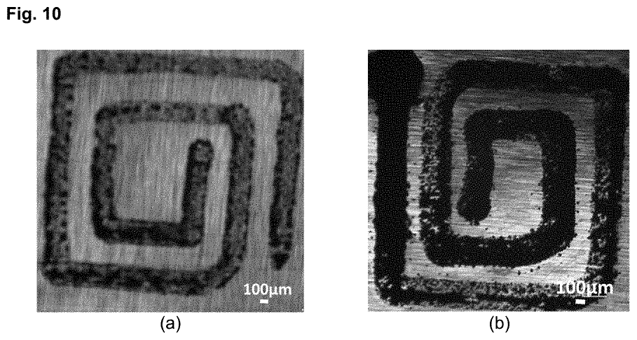

Another experiment was performed for comparison of the new process with the conventional vapor phase polymerization process. In this experiment, oxidant graphene oxide was mixed with NMC 811 (LiNi_{0.8}Co_{0.10}Mn_{0.10}O₂) and polymerized with the EDOT monomer by our new approach and the conventional vapor phase polymerization. From the SEM image analysis, it was observed that the polymer PEDOT formed on the surface of the NMC particles using the new polymerization technique (FIG. 9, panel (a)). In contrast, the polymer PEDOT was formed only on the surface after the vapor phase polymerization (FIG. 9, panel (b)). In the inset figures of high resolution, it is clearly observed that the PEDOT formed by the new approach is surrounded the NMC 811 particles while for the vapor phase polymerization process, polymer is deposited on the surface only.

The conductivity of these samples was also measured. The conductivity of the sample made by the new approach was 211.2 S/cm and the electrical conductivity of the sample made by the vapor phase polymerization process was 130.6 S/cm. Accordingly, the new approach provides for enhanced electrical conductivity as well as a bulk structure of the PEDOT conductive polymer.

### Example 4

In this experiment, the oxidant (FeCl₃) layer was developed in a structural form to investigate the printability of the oxidant. Different ratios of the FeCl₃ oxidant powder and acetonitrile solvent were evaluated to obtain the optimized extrudable concentration of the oxidant solution. After preparing the oxidant layer, the substrate with the oxidant layer was placed inside the polymerization chamber for to prepare PEDOT from the EDOT monomer. In order to vaporize the monomer, the temperature was maintained at 70° C. via a hot plate. The processing time was 3 hours, after which the vaporization of monomer solution was complete and the maximum amount of PEDOT was obtained from the vapor phase polymerization process.

The conductive polymer PEDOT was also manufactured from the monomer solution (EDOT and acetonitrile) according to the new procedure described in Example 2. The polymerized PEDOT maintained the structures after using both polymerization techniques (FIG. 10). Interestingly, the PEDOT formed by the new approach (named as OUR approach) was very defined (FIG. 10, panel (a)), indicating that no PEDOT formation occurred outside the oxidant layers. However, in the PEDOT formed by vapor phase polymerization technique, some tiny particles of PEDOT existed outside the oxidant layers (FIG. 10, panel (b)). In vapor phase polymerization, the EDOT monomer vapor travels to the oxidant and reacts with the Cl⁻ ion in the FeCl₃ oxidant, which creates resonance in the EDOT monomers resulting in bonding between the monomer particles to form the PEDOT polymer. At some point, due to the random deposition during the EDOT vaporization process, small amounts of PEDOT were produced and deposited on the outside region of the oxidant. However, with the new approach, the EDOT monomer was supplied locally to the oxidant layer, which could control the deposition of EDOT during the polymer formation so that PEDOT particles cannot be formed in the outside region.

### Example 5

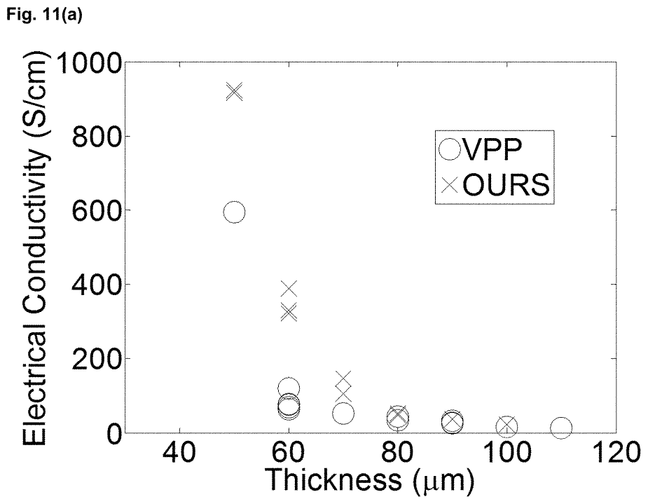

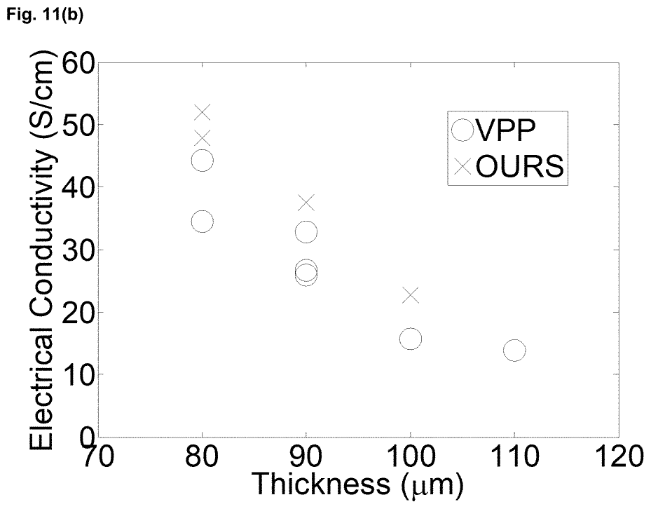

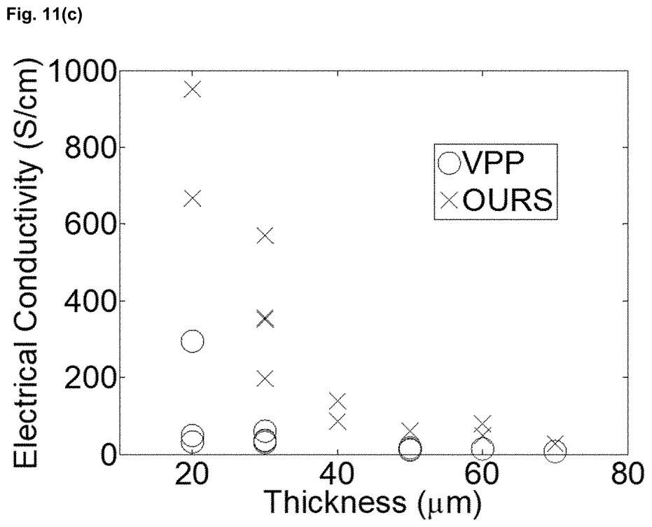

The thickness of the PEDOT is dependent on the thickness of the oxidant layer. There exists an optimal thickness for the oxidant layer that can achieve the maximum conversion of the EDOT monomer into PEDOT and, therefore, the maximum achievable conductivity of the layers. To observe the thickness relation between the oxidant and the PEDOT layer, the conductivity was measured in PEDOT prepared by a vapor phase polymerization process and the approach of the present invention (FIGS. 11(a)-11(c)). It was observed that greater thicknesses of PEDOT reduced the electrical conductivity for both approaches. For a 30-micron thick sample, PEDOT formed by our approach showed 1.6 times higher conductivity than the PEDOT formed by a vapor phase polymerization process (FIG. 11(a)). For thicker samples ranging between 80 to 100 micron, the electrical conductivity is 1.4 times more in our approach as compared to vapor phase polymerization process (FIG. 11(b)).

According to our approach, the development of the structure of PEDOT is fabricated by a layer-by-layer fashion so that a continuous bulk structure is formed. If PEDOT is only formed on the surface layers of the oxidant, then the conductivity of the bulk structure (e.g. inside of the layer) should be low. To further investigate this effect, the conductivity of the bulk structure was measured via a scratching test. The PEDOT prepared by both approaches were scratched four times using a razor blade to remove the surface layers from the PEDOT structures. After scratching, the bulk material was revealed and the thickness and conductivity of the PEDOT samples were measured. It was observed that the conductivity inside the PEDOT structure formed by our approach was higher than the conductivity of PEDOT structure formed by a vapor phase polymerization process (FIG. 11(c)).

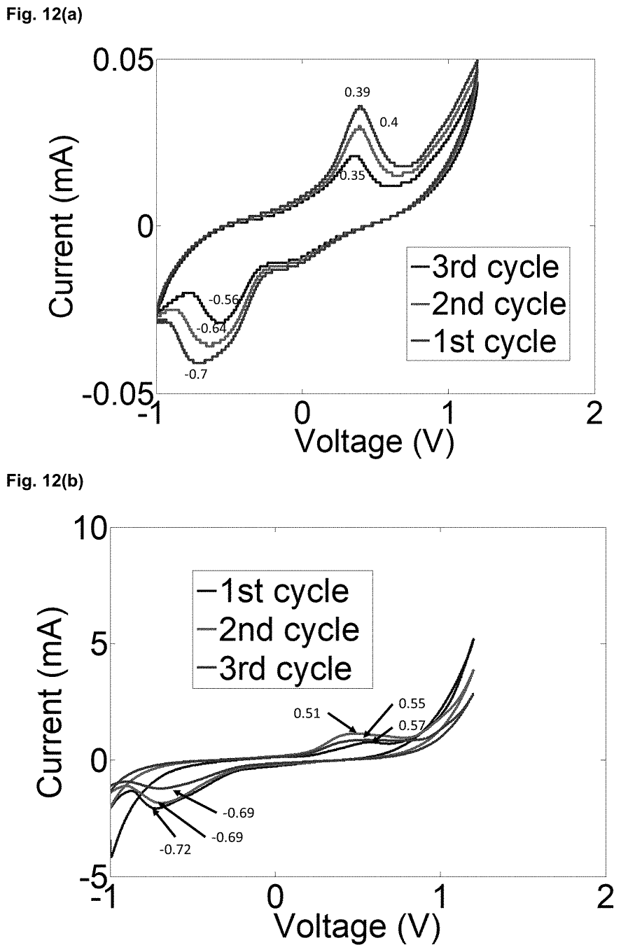

The reactivity of the PEDOT by a cyclic voltammetry (CV) test was also investigated. The CV test was done at a voltage range of −1.0 V to +1.2 V, as the PEDOT undergoes oxidation and reduction reactions in this voltage range. For both the PEDOT samples formed by our approach and vapor phase polymerization process, oxidation and reduction peaks were observed (FIG. 12(a) and FIG. 12(b), respectively). In our approach, the reduction peaks occurred at ˜0.4V and oxidation peaks were found at ˜0.65V. In vapor phase polymerization process, the reduction peaks were formed at ˜0.55V and oxidation peaks formed at ˜0.7V. The peaks are different between the approaches, which indicated that there was some amount of oxidant (FeCl₃) still in the structure. According to Nernst Equation (equation 1), if more reduction occurs, then the reduction peaks shift left, and if more oxidation occurs, then oxidation peaks shift right. Therefore, there are two possible reactions (equation 2 and equation 3) that can be occurring. If reaction 2 occurs, then the PEDOT bond will break in some regions and form oligomers of PEDOT (i.e., low molecular weight polymers comprising a small number of repeat units whose physical properties are significantly dependent on the length of the chain). If reaction 3 occurs, that means a higher amount of FeCl₃ oxidant is present after the polymerization technique. Neither of these reactions are desirable for the PEDOT structures. From FIG. 12(a) and FIG. 12(b), it was observed that the peaks were formed at higher currents in the PEDOT formed by vapor phase polymerization process than the PEDOT formed by our approach. Higher current peaks are formed due to the presence of higher amount of reactants in the reactions. Therefore, a higher amount of reactive FeCl₃ or PEODT was present in the vapor phase polymerization process samples. However, the PEDOT formed by our approach was not very reactive, which means it can transfer current without participating in reaction 2 and reaction 3. The reason for this stability in PEDOT made by our approach, is the formation of bulk structured PEDOT. However, in vapor phase polymerization process, PEDOT was formed on top of the oxidant layer which makes it more reactive during cyclic voltammetry test.

$$E = {E}^{0} + \frac{RT}{nF} ln \frac{( Ox )}{( Red )} \qquad [ 1 ]$$

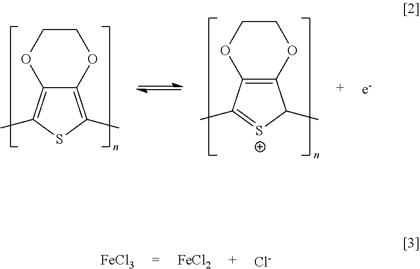

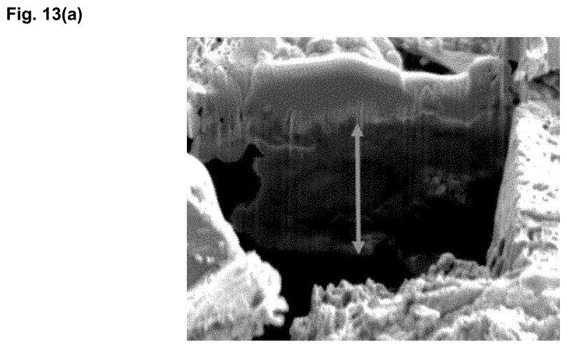

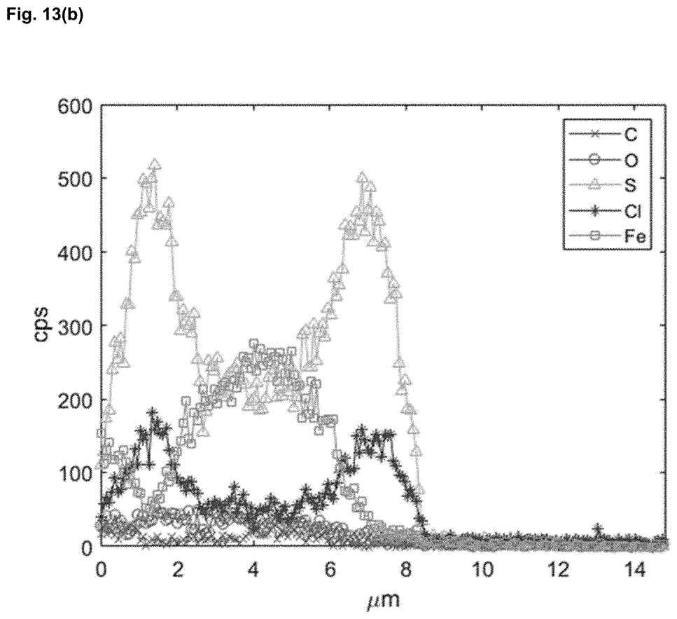

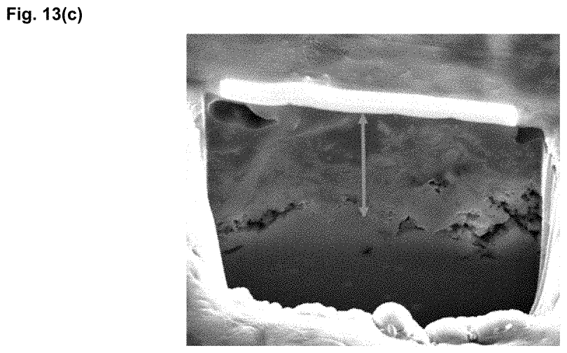

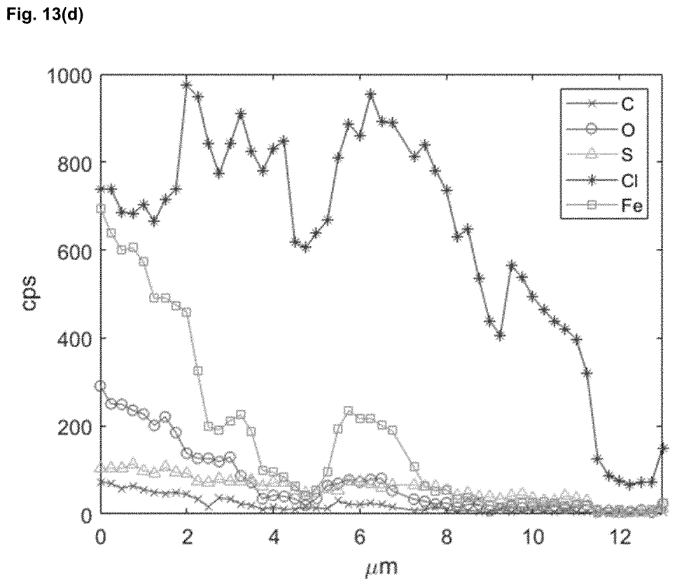

In order to investigate the inner structure and composition of the PEDOT structures, Focused-ion Beam Scanning Electron Microscopy (FIB-SEM) equipped with an Energy-Dispersive X-ray Spectroscopy (EDS) analyzer was used. In FIB-SEM, the PEDOT was cut from the surface to expose the inner material (FIG. 13(a) and FIG. 13(c)). The inner material was then analyzed. From the EDS results, the presence of different elements inside the PEDOT structure formed by our approach (FIG. 13(b)) and by vapor phase polymerization process (FIG. 13(d)) was observed. Sulfur peaks are generated from PEDOT or EDOT, and CI peaks are generated from the FeCl₃ oxidant. From the EDS analysis, it was observed that both the samples contained CI and S. In comparison with the results, the cps level of S was higher in PEDOT made by our approach than vapor phase polymerization process samples both at the surface and in the exposed material, which means that the S content was higher in our approach. Another observation found that the Cl and Fe content was very high in the PEDOT formed by vapor phase polymerization process than the PEDOT samples formed by our technique. This confirms the presence of a higher amount of oxidant remaining after the vapor phase polymerization process than our approach.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above compositions and processes without departing from the scope of the invention, it is intended that all matter contained in the above description and shown in the accompanying drawings shall be interpreted as illustrative and not in a limiting sense.

1. A process for forming a three-dimensional electrically conductive structure comprising:
depositing a first quantity of an oxidant for a monomer onto a substrate;
depositing a first quantity of the monomer onto the oxidant to polymerize the monomer and form a first layer of a conductive polymer;
depositing a second quantity of the oxidant onto the first layer of the conductive polymer; and
depositing a second quantity of the monomer onto the second quantity of the oxidant to polymerize the monomer and form a second layer of the conductive polymer,
wherein the monomer is selected from the group consisting of thiophene; 3,4-ethylenedioxythiophene; pyrrole; and aniline, and
wherein the conductive polymer is selected from the group consisting of polythiophene; poly(3,4-ethylenedioxythiophene); polypyrrole; and polyaniline.

2. The process of claim 1, further comprising repeating the foregoing steps of depositing the oxidant and depositing the monomer to form a plurality of layers of the conductive polymer.

3. (canceled)

4. The process of claim 1, wherein the monomer and the oxidant for the monomer are sprayed simultaneously toward a substrate, wherein the 3,4-ethylenedioxythiophene monomer and the oxidant react with each other to form conductive polymer disposed on the substrate.

5. The process of claim 4, wherein the monomer and the oxidant for the monomer are sprayed through a nozzle device which keeps the monomer and the oxidant for the monomer separate until exiting the nozzle device.

6. The process of claim 5, wherein the nozzle device comprises an inner nozzle and an outer nozzle.

7. (canceled)

8. The process of claim 1, further comprising atomizing the monomer prior to deposition.

9. The process of claim 8, wherein the monomer is atomized by a technique selected from the group consisting of electro-spraying, ultrasonic atomization, rotating disk atomization, spray cooling atomization, and combinations thereof.

10. The process of claim 1, wherein the monomer comprises 3,4-ethylenedioxythiophene and the conductive polymer comprises poly(3,4-ethylenedioxythiophene).

11. The process of claim 1, wherein the oxidant for the monomer comprises at least one component selected from the group consisting of ferric chloride, ferric nitrate, iron (III) p-toluenesulfonate (FeTos), molybdenum chloride, and graphene oxide (GO).

12. The process of claim 1, wherein the oxidant for the monomer and/or the monomer are provided as mixtures with one or more organic solvents.

13-18. (canceled)

19. A process for forming a three-dimensional electrically conductive structure comprising:
simultaneously spraying a monomer and an oxidant for the monomer toward a substrate, wherein the monomer and the oxidant react with each other to form a conductive polymer disposed on the substrate,
wherein the monomer is selected from the group consisting of thiophene; 3,4-ethylenedioxythiophene; pyrrole; and aniline, and
wherein the conductive polymer is selected from the group consisting of polythiophene; poly(3,4-ethylenedioxythiophene); polypyrrole; and polyaniline.

20. The process of claim 19, wherein the monomer and the oxidant for the monomer are sprayed through a nozzle device which keeps the monomer and the oxidant for the monomer separate until exiting the nozzle device.

21. The process of claim 20, wherein the nozzle device comprises an inner nozzle and an outer nozzle.

22. (canceled)

23. The process of claim 19, further comprising repeating the spraying step of the oxidant and depositing the monomer to form a plurality of layers of the conductive polymer.

24. (canceled)

25. The process of claim 19, further comprising atomizing the monomer prior to spraying.

26. The process of claim 25, wherein the monomer is atomized by a technique selected from the group consisting of electro-spraying, ultrasonic atomization, rotating disk atomization, spray cooling atomization, and combinations thereof.

27. The process of claim 19, wherein the monomer comprises 3,4-ethylenedioxythiophene and the conductive polymer comprises poly(3,4-ethylenedioxythiophene).

28. The process of claim 19, wherein the oxidant for the monomer comprises at least one component selected from the group consisting of ferric chloride, ferric nitrate, iron (III) p-toluenesulfonate (FeTos), molybdenum chloride, and graphene oxide (GO).

29. The process of claim 19, wherein the oxidant for the monomer and/or the monomer are provided as mixtures with one or more organic solvents.

30-35. (canceled)

36. A material comprising:
a substrate, and
a three-dimensional electrically conductive structure comprising a plurality of layers of a conductive polymer disposed on the substrate,
wherein the conductive polymer is selected from the group consisting of polythiophene; poly(3,4-ethylenedioxythiophene); polypyrrole; and polyaniline.

37-41. (canceled)
